(19) United States
(12) Patent Application Publication
(10) Pub. No.: US 2011/0049111 A1
(43) Pub. Date: Mar. 3, 2011

(54) COLOR SYSTEM FOR ETCHING GAS

(76) Inventors: Sungyong KO, Suwon-city (KR); Minshik KIM, Suwon-city (KR); Byoungil LEE, Suwon-city (KR); Heeseok MOON, Suwon-city (KR); Kwangmin LEE, Suwon-city (KR); Keehyun KIM, Suwon-city (KR); Weonmook LEE, Suwon-city (KR)

(21) Appl. No.: 12/854,409

(22) Filed: Aug. 11, 2010

(30) Foreign Application Priority Data
Aug. 28, 2009 (KR) 10-2009-0080216

(51) Int. Cl. B23K 10/00

(52) U.S. Cl. 219/121.43

(57) ABSTRACT

A control system for etching gas is provided. The control system includes a mass flow control unit, a flow rate control unit, and a tuning gas control unit. The mass flow control unit controls a mass flow of an etching gas input to a chamber. The flow rate control unit distributes the etching gas to an upper gas injector and a side gas injector connected with the mass flow control unit and installed in the chamber. The tuning gas control unit distributes and supplies a supplementary gas and tuning gas controlling an ion density and distribution of plasma within the chamber, to the mass flow control unit and the flow rate control unit.

### CROSS REFERENCE

This application claims foreign priority under Paris Convention and 35 U.S.C. §119 to Korean Patent Application No. 10-2009-0080216, filed Aug. 28, 2009 with the Korean Intellectual Property Office.

### BACKGROUND OF THE INVENTION

1. Technical Field

The present invention relates to a control system for etching gas applied to a plasma etching device. More particularly, the present invention relates an etching gas control system, for not only improving an etching rate and etching uniformity of a wafer surface but also being capable of controlling a Critical Dimension (CD) difference between a central part of a wafer and an edge part, by building a tuning gas control system (e.g., a Supplementary Gas Control (SGC) system) capable of independently controlling and selectively supplying a supplementary gas and tuning gas capable of controlling plasma uniformity or distribution to an upper gas injector and a side gas injector.

2. Description of the Related Art

In general, a semiconductor Integrated Circuit (IC) device selectively removes only part of a wafer or a thin film deposited on the wafer, thereby forming an ultra miniature structure of a desired form on a surface to form a circuit of a complex structure. At this time, thin film manufacturing is implemented through many manufacturing processes such as a rinse process, a deposition process, a photolithography process, a plating process, an etching process, etc.

Among the various processes, the etching process is a process of removing desired materials from a wafer surface through a chemical reaction by jetting an etching gas (e.g., carbon tetrafluoride (CF₄), chlorine gas (Cl₂), Hydrogen Bromide (HBr), etc.) into a chamber installing a wafer therein using a gas injector. The etching process selectively removes a portion not coated with a photoresist using a photoresist pattern formed in the photolithography process as a mask, thereby forming a minute circuit on a substrate.

Thus, it is of importance to maintain the same etching rate on the whole surface of a wafer and also, vertically form an etching section shape to form a thin film in the same pattern as the photoresist pattern formed in the photoresist.

However, the etching process induces a difference of an etching speed due to a chemical and physical reaction, thus resulting in a phenomenon of a failure to form a uniform etching rate or CD throughout the surface of the wafer.

In order to solve this, the conventional art installs a gas injector at a top of a chamber of an etching equipment, and performs an etching process of controlling an etching gas supplied to the gas injector by means of a flow rate controller to control an amount and distribution of an etching gas input into the chamber.

Also, the gas injectors are installed at a top and side of the chamber, respectively, and selectively control a jet amount and flow of an etching gas, thereby controlling an ion density and distribution of the etching gas to control wafer etching uniformity.

However, the conventional etching equipment has the following problems.

Firstly, the etching equipment has a limitation in obtaining a uniform etching rate throughout the surface of a recent large-size wafer of 12 inches (300 mm).

Secondly, the etching equipment cannot independently control a supplementary gas (e.g., argon (Ar), helium (He), xenon (Xe), etc.) that is an inert gas used for controlling a dilution or residual time of an etching gas.

Thirdly, because of the absence of an independent tuning gas supply means capable of minutely controlling the ion density or distribution of the etching gas, the etching equipment neither sufficiently secures an etching uniformity nor corrects the CD difference between the central part and edge part of the wafer or artificially generates a CD difference.

Secondly, because the baffle plate is not effectively grounded to the chamber, there is a problem that there occurs a plasma flickering phenomenon in which plasma between the vents is irregularly flickered.

Thirdly, because of the absence of a control means for controlling aperture ratios of the vents, there is a problem that it is impossible to minutely control an etching rate of the substrate through control of a gas flow or exhaust flow within the chamber.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to provide a control system for etching gas, for controlling an etching rate and etching uniformity of a wafer surface, by independently controlling and selectively supplying a supplementary gas and tuning gas capable of controlling plasma uniformity within a chamber to an upper gas injector and a side gas injector.

Another aspect of exemplary embodiments of the present invention is to provide a control system for etching gas, for compensating a Critical Dimension (CD) difference between a central part of a wafer surface and an edge part or artificially generating a CD difference, by selectively diversely controlling a jet amount and input path of a supplementary gas and tuning gas to control an ion density and distribution of plasma within a chamber.

According to one aspect of the present invention, a control system for etching gas is provided. The system includes a mass flow control unit, a flow rate control unit, and a tuning gas control unit. The mass flow control unit controls a mass flow of an etching gas input to a chamber. The flow rate control unit distributes the etching gas to an upper gas injector and a side gas injector connected with the mass flow control unit and installed in the chamber, respectively. The tuning gas control unit distributes and supplies a supplementary gas and tuning gas controlling an ion density and distribution of plasma within the chamber, to the mass flow control unit and the flow rate control unit, respectively.

The flow rate control unit includes a flow rate controller and a gas distribution duct. The gas distribution duct includes a plurality of outlet ducts, first and second supply ducts branched from the one-side outlet duct and connected to a center nozzle and side nozzle of the upper gas injector, respectively, and third and fourth supply ducts branched from the other-side outlet duct and connected to the side nozzle and the side gas injector, respectively.

The second and third supply ducts are integrated into a fifth supply duct and is connected to the side nozzle.

Open/close valves are installed in outlet ducts provided in the mass flow control unit and the first, second, third, and fourth supply ducts, respectively.

The tuning gas control unit includes a supplementary gas supplier for supplying a supplementary gas to the mass flow control unit, and a tuning gas supplier for supplying a tuning gas to the flow rate controller.

The tuning gas control unit includes a plurality of tuning gas flow controllers supplying one or more different tuning gases, respectively.

The tuning gas supplier includes a first tuning gas flow controller for supplying a plasma active gas, and a second tuning gas flow controller for supplying a supplementary etching gas.

The supplementary gas supplier connects to the outlet ducts of the mass flow control unit through a sixth supply duct, and the first tuning gas flow controller and second tuning gas flow controller connect to the gas distribution duct through a seventh supply duct.

The flow rate control unit includes a flow rate controller and a gas distribution duct. The gas distribution duct includes a plurality of outlet ducts, first and second supply ducts branched from the one-side outlet duct and connected to a center nozzle and side nozzle of the upper gas injector, respectively, and third and fourth supply ducts branched from the other-side outlet duct and connected to the side nozzle and the side gas injector, respectively. The second and third supply ducts are integrated into a fifth supply duct and connected to the side nozzle. The seventh supply duct installs a branch point (D), and the branch point installs branch ducts connected to the first, fourth, and fifth supply ducts, respectively.

Open/close valves are installed in outlet ducts provided in the first tuning gas flow controller and second tuning gas flow controller and the branch ducts, respectively.

The sixth supply duct installs a branch point (C), and has a connection duct connecting the branch point (C) and the seventh supply duct.

Open/close valves are installed in the sixth supply duct branched from the branch point (C) and the connection duct, respectively.

The active gas can be an O₂ or N₂ gas.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic cross section illustrating a plasma etching device including an upper gas injector and a side gas injector;

FIG. 2 is a diagram illustrating a construction of a control system for an etching gas according to the present invention;

FIG. 3 is a graph illustrating a variation of an etching rate of a wafer in case that oxygen (O₂), one of active gases, is not supplied and in case that O₂ is supplied through a different path; and

FIG. 4 is a graph illustrating a variation of an etching rate of a wafer in case that carbon fluoride (CF₄), one of supplementary etching gases, is not supplied and in case that CF₄ is supplied through a different path.

Throughout the drawings, the same drawing reference numerals will be understood to refer to the same elements, features and structures.

### DESCRIPTION OF SPECIFIC EMBODIMENTS

Exemplary embodiments of the present invention will now be described in detail with reference to the annexed drawings. In the following description, a detailed description of known functions and configurations incorporated herein has been omitted for conciseness.

A description is made below in detail with reference to the accompanying drawings.

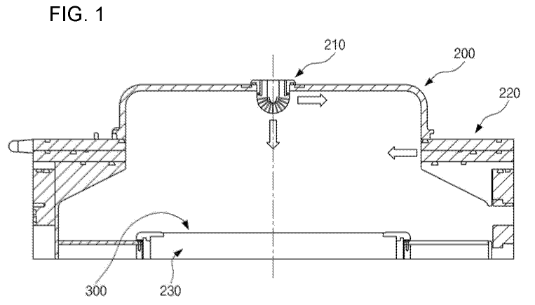

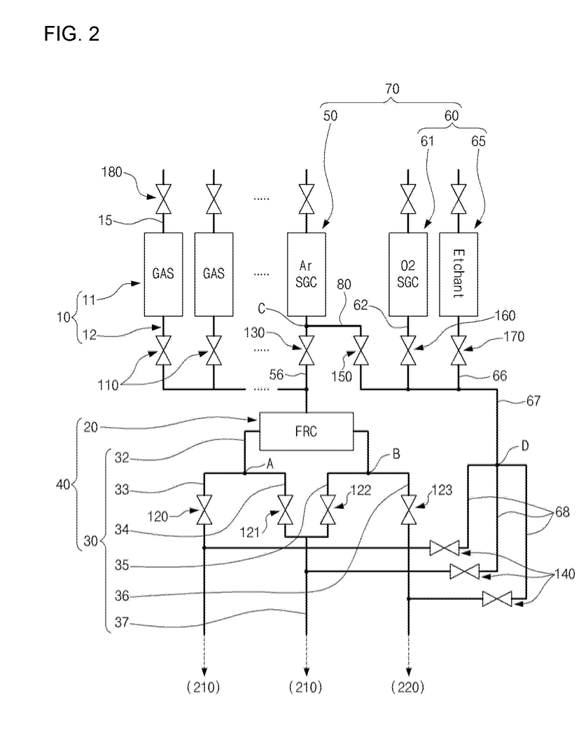

FIG. 1 is a schematic cross section illustrating a plasma etching device including an upper gas injector and a side gas injector. FIG. 2 is a diagram illustrating a construction of a control system for an etching gas according to the present invention.

As illustrated in FIG. 1, the plasma etching device includes a chamber 200 forming a plasma reaction space therein, an upper gas injector 210 installed at a top and center of the chamber 200, and a side gas injector 220 installed at a side of the chamber 200.

A wafer 300 is loaded on an upper surface of a stage 230 installed at a center of the chamber 200.

The upper gas injector 210 and the side gas injector 220 inject an etching gas into the chamber 200.

The upper gas injector 210 includes a center nozzle jetting an etching gas in a downward direction and a side nozzle jetting the etching gas in a lateral direction. Thus, the upper gas injector 210 simultaneously injects the etching gas in the central and lateral direction of the chamber 200. The side gas injector 220 is installed to inject the etching gas in a lateral direction of the wafer 300.

Thus, by simultaneously jetting the etching gas in an upper and lateral direction of the wafer 300, an ion density or distribution of a plasma state can be relatively uniformly formed compared to a case that only the upper gas injector 210 is installed.

As illustrated in FIG. 2, the etching gas control system according to the present invention includes a mass flow control unit 10, a flow rate control unit 40, and a tuning gas control unit 70.

The mass flow control unit 10 controls a mass flow of an etching gas supplied into the chamber 200, and includes a Mass Flow Controller (MFC) 11 and an outlet duct 12.

The mass flow controller 11 connects with a gas supply device (not shown) for etching gas through a gas inlet duct 15, and connects with a Flow Rate Controller (FRC) 20 of the flow rate control unit 40 through the outlet duct 12. So, the mass flow controller 11 receives the etching gas from the gas supply device and inputs a suitable mass flow to the flow rate controller 20.

Generally, the etching gas may be a gas such as hydrogen bromide (HBr), chlorine (Cl₂), tetra fluoro methane (CF₄), octa fluoro cyclo butane (C₄F₈), hexafluoro-1,3-butadiene (C₄F₆), tri fluoro methane (CHF₃), di fluoro methane (CH₂F₂), sulfur hexa fluoride (SF₆), etc.

The mass flow controllers 11 can be plurally installed in parallel with each other in the mass flow control unit 10 to selectively supply several kinds of different main etching gases. Open/close valves 180 and 110 are installed in the gas inlet duct 15 and the outlet duct 12, which are connected to the mass flow controller 11, respectively, to make etching gas supply and cutoff possible.

Accordingly, the mass flow control unit 10 can selectively supply a different etching gas to the flow rate control unit 40 using the respective mass flow controllers 11 and open/close valves 110.

The flow rate control unit 40 includes the flow rate controller 20 and a gas distribution duct 30.

The flow rate controller 20 distributes and supplies a main etching gas to the upper gas injector 210 and side gas injector 220 installed in the chamber 200, and connects with the outlet duct 12 of the mass flow control unit 10.

Accordingly, the flow rate control unit 40 receives an etching gas through the outlet duct 12 from the mass flow controller 11 and supplies the received etching gas to the upper gas injector 210 and side gas injector 220 through the gas distribution duct 30. At this time, the flow rate control unit 40 diversely controls an amount of an etching gas to distribute and supply the etching gas to the upper gas injector 210 and the side gas injector 220, respectively.

The gas distribution duct 30 includes two outlet ducts 32 each installed in the flow rate controller 20, and includes first, second, third, fourth, and fifth supply ducts 33, 34 35, 36, and 37.

The outlet ducts 32 form branch points (A) and (B), respectively and thus, the outlet ducts 32 are branched into the first, second, third, and fourth supply ducts 33, 34, 35, and 36, respectively.

The first supply duct 33 connects to the center nozzle of the upper gas injector 210. The second and third supply ducts 34 and 35 connect to the side nozzle of the upper gas injector 210. The fourth supply duct 36 connects to the side gas injector 220.

Thus, an etching gas going through the first supply duct 33 is downwardly jet to a center of the chamber 200 through the center nozzle of the upper gas injector 210. Etching gases going through the second and third supply ducts 34 and 35 are jet in the lateral direction of the chamber 200 through the side nozzle of the upper gas injector 210. An etching gas going through the fourth supply duct 36 is jet from the side of the chamber 200 to the center of the wafer 300 through the side gas injector 220.

The second and third supply ducts 34 and 35 are integrated into the fifth supply duct 37 and simultaneously, can connect to the side nozzle of the upper gas injector 210.

Open/close valves 120, 121, 122, and 123 can be installed in the first, second, third, and fourth supply ducts 33, 34, 35, and 36, respectively.

Thus, the flow rate control unit 40 can distribute and supply a suitable amount of etching gas to the upper gas injector 210 and side gas injector 220, and can selectively open the open/close valves 120, 121, 122, and 123 to variously control an input path of an etching gas through the first, second, third, and fourth supply ducts 33, 34, 35, and 36 as well.

Also, the flow rate control unit 40 can variously control amounts of etching gases jet from the center nozzle and side nozzle of the upper gas injector 210 and the side gas injector 220, by relatively controlling amounts of etching gases supplied to the first, second, third, and fourth supply ducts 33, 34, 35, and 36 using the flow rate controller 20.

The tuning gas control unit 70 connects to the mass flow control unit 10 and the flow rate control unit 40 to supply a supplementary gas and tuning gas to the mass flow control unit 10 and the flow rate control unit 40. The tuning gas control unit 70 includes a supplementary gas supplier (e.g., a Supplementary Gas Controller (SGC)) 50 and a tuning gas supplier 60.

The supplementary gas supplier 50 supplies a supplementary gas for controlling a dilution or residual time of an etching gas. Here, the supplementary gas can be an inert gas such as argon (Ar), helium (He), xenon (Xe), etc.

The supplementary gas supplier 50 can install a mass flow controller 10 to supply or cut off a suitable amount of supplementary gas.

The supplementary gas supplier 50 connects to the outlet duct 12 of the mass flow control unit 10 by means of a sixth supply duct 56. Also, an open/close valve 130 is installed in the sixth supply duct 56 to make supplementary gas supply and cutoff possible.

Thus, the supplementary gas supplier 50 can mix a supplementary gas with an etching gas through the sixth supply duct 56 and supply the mixed gas to the flow rate controller 20. The etching gas and the supplementary gas are mixed with each other and are distributed and supplied to the upper gas injector 210 and the side gas injector 220 through the flow rate controller 20 and the gas distribution duct 30, respectively.

The tuning gas supplier 60 connects to the gas distribution duct 30 to supply a plasma active gas or supplementary etching gas. The tuning gas supplier 60 includes a first tuning gas flow controller (e.g., a SGC) 61 and a second tuning gas flow controller 65.

However, the tuning gas supplier 60 is not limited to the first tuning gas flow controller 61 and the second tuning gas flow controller 65, and can include a plurality of tuning gas flow controllers supplying different active gases or supplementary etching gases, respectively.

The first tuning gas flow controller 61 connects to a seventh supply duct 67 through an outlet duct 62 to supply an active gas (O₂ or N₂) to the gas distribution duct 30 through the seventh supply duct 67.

At this time, the active gas is mixed with an etching gas in the gas distribution duct 30 and is supplied to the upper gas injector 210 and the side gas injector 220, thereby activating plasma of the etching gas within the chamber 200 and controlling an ion density or distribution of the plasma, thus improving an etching rate.

Here, it is desirable that the first tuning gas flow controller 61 installs an open/close valve 160 in the outlet duct 62 to make active gas supply and cutoff possible.

The second tuning gas flow controller 65 additionally supplies a supplementary etching gas to improve an etching rate. The second tuning gas flow controller 65 connects to the seventh supply duct 67 through an outlet duct 66 to supply the supplementary etching gas to the gas distribution duct 30 through the seventh supply duct 67.

An open/close valve 170 can be installed in the outlet duct 66.

The seventh supply duct 67 connects to the gas distribution duct 30 of the flow rate control unit 40 such that an active gas or a supplementary etching gas is supplied to the upper gas injector 210 or the side gas injector 220. The seventh supply duct 67 installs a branch point (D) and forms a plurality of branch ducts 68. After that, the branch ducts 68 are connected to the first, fourth, and fifth supply ducts 33, 36, and 37 of the gas distribution duct 30, respectively.

Also, open/close valves 140 are installed in the branch ducts 68, respectively.

Accordingly, the seventh supply duct 67 selectively supplies an active gas or supplementary etching gas, which is a tuning gas, to the upper gas injector 210 and the side gas injector 220 through the first, fourth, and fifth supply ducts 33, 36, and 37 via the branch ducts 68.

The sixth supply duct 56 provided in the supplementary gas supplier 50 can connect with the seventh supply duct 67 through a connection duct 80 in which an open/close valve 150 is installed.

Thus, the supplementary gas supplier 50 closes the open/close valve 150 of the connection duct 80 such that a supplementary gas can be mixed with an etching gas and supplied through the flow rate controller 20. Or, the supplementary gas supplier 50 closes the open/close valve 130 of the sixth supply duct 56 and opens the open/close valve 150 of the connection duct 80 such that a supplementary gas can be mixed with an active gas or supplementary etching gas and supplied to the gas distribution duct 30 through the seventh supply duct 67.

Accordingly, the present invention can either mix a supplementary gas with a main etching gas and supply the mixed gas to the upper gas injector 210 and the side gas injector 220 through the flow rate controller 20 and the gas distribution duct 30, or can mix a supplementary gas with an active gas or supplementary etching gas and supply the mixed gas through the seventh supply duct 67 and the gas distribution duct 30. Also, the present invention can selectively open or close the open/close valves 140 of the branch ducts 68 to independently control a supplementary gas and tuning gas, thus selectively supplying the supplementary gas and tuning gas to each of the upper gas injector 210 and the side gas injector 220.

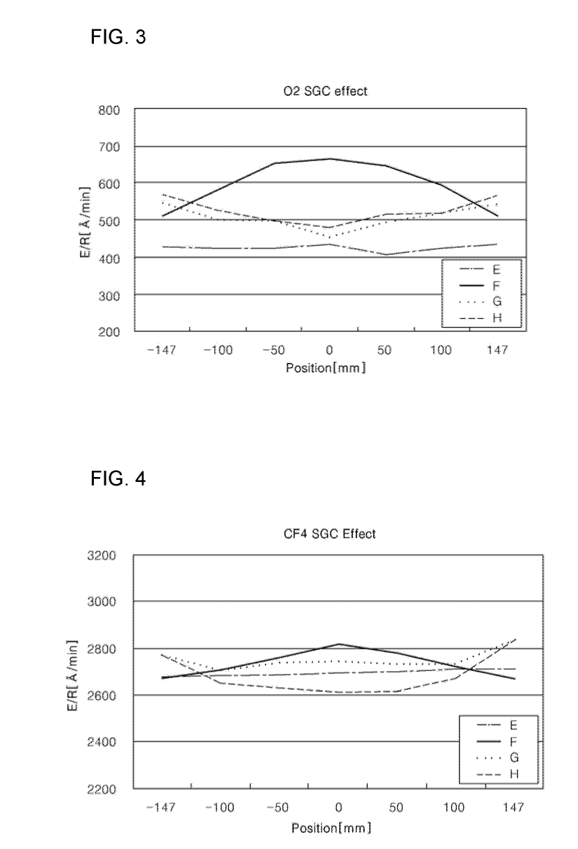

Experiment results of an exemplary embodiment of the present invention are described below with reference to FIGS. 3 and 4.

FIG. 3 is a graph illustrating respective Etching Rates (E/R) of a wafer 300 in case that O₂, one of active gases, is not supplied and in case that O₂ is selectively supplied through a different path. FIG. 4 is a graph illustrating etching rates in case that a supplementary etching gas (CF₄) is not supplied and in case that a supplementary etching gas (CF₄) is selectively supplied through a different path.

In FIGS. 3 and 4, horizontal axes denote left and right positions based on a central part ‘0’ between edge parts ‘−147’ and ‘+147’ of the wafer 300, and vertical axes denote etching rates (E/R) dependent on a corresponding position on the wafer 300 shown in horizontal axis.

In FIG. 3, it can be appreciated that, in ‘E’ case that an active gas (O₂) is not supplied, the central and edge parts of the wafer 300 have no great difference in etching rate and, unlike this, in ‘F’ case that the active gas (O₂) flows through the seventh supply duct 67 and the branch duct 68 and is supplied to the center nozzle of the upper gas injector 210 through the first supply duct 33, the central part of the wafer 300 has a relatively high etching rate compared to the edge parts of the wafer 300.

Also, it can be appreciated that, in ‘G’ case that the active gas (O₂) is supplied to the side nozzle of the upper gas injector 210 through the fifth supply duct 37 and in ‘H’ case that the active gas (O₂) is supplied to the side gas injector 220 through the fourth supply duct 36, the edge parts of the wafer 300 have a relatively high etching rate compared to the central part of the wafer 300.

In FIG. 4, it can be appreciated that, even in case that a supplementary etching gas (CF₄) instead of the active gas (O₂) is supplied to the same path as that of an exemplary embodiment of FIG. 3, a difference of an etching rate between the central part and edge parts of the wafer 300 shows the same trend as that of the graph of FIG. 3.

That is, the active gas (O₂) activates plasma in a jet position within the chamber 200, thus increasing the etching rate. The supplementary etching gas (CF₄) improves an ion density of plasma in the jet position, thus improving the etching rate.

Accordingly, by selectively supplying or cutting off a supplementary gas, an active gas, and a supplementary etching gas using a tuning gas control unit, the present invention can variously control a jet amount and flow of a tuning gas, control an ion density or distribution of plasma in a desired position, and control etching rates of a central part of a wafer 300 and edge parts. By doing so, the present invention can control an etching rate and etching uniformity of a surface of a wafer 300 and, in addition, the present invention can compensate a CD difference between the central part and edge parts or artificially control a CD difference.

As described above, firstly, the present invention has an effect of, by variously controlling a jet amount and input path of a supplementary gas or tuning gas, being capable of forming the optimum etching condition through a control of an ion density or distribution of plasma within a chamber to improve an etching rate and etching uniformity of a wafer surface, minimizing an error rate of a wafer. Secondly, the present invention has an effect of, even in case that a large size wafer is input, not only securing an etching uniformity of a central part and edge parts of a wafer but also compensating a CD difference or artificially generating a CD difference, thus improving process efficiency.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A control system for etching gas, comprising:
a mass flow control unit for controlling a mass flow of an etching gas that is input to a chamber;
a flow rate control unit for distributing the etching gas to an upper gas injector and a side gas injector connecting with the mass flow control unit and installed in the chamber, respectively; and
a tuning gas control unit for distributing and supplying a supplementary gas and tuning gas controlling an ion density and distribution of plasma within the chamber, to the mass flow control unit and the flow rate control unit, respectively.

2. The system of claim 1, wherein the flow rate control unit comprises a flow rate controller and a gas distribution duct, and
wherein the gas distribution duct comprises:
a plurality of outlet ducts;
first and second supply ducts branched from the one-side outlet duct and connected to a center nozzle and a side nozzle of the upper gas injector, respectively; and
third and fourth supply ducts branched from the other-side outlet duct and connected to the side nozzle of the upper gas injector and the side gas injector, respectively.

3. The system of claim 2, wherein the second and third supply ducts are integrated into a fifth supply duct and is connected to the side nozzle of the upper gas injector.

4. The system of claim 2, wherein open/close valves are installed in outlet ducts provided in the mass flow control unit and the first, second, third, and fourth supply ducts, respectively.

5. The system of claim 1, wherein the tuning gas control unit comprises:
a supplementary gas supplier for supplying a supplementary gas to the mass flow control unit; and
a tuning gas supplier for supplying a tuning gas to the flow rate controller.

6. The system of claim 5, wherein the tuning gas control unit comprises a plurality of tuning gas flow controllers supplying one or more different tuning gases, respectively.

7. The system of claim 5, wherein the tuning gas supplier comprises:
a first tuning gas flow controller for supplying a plasma active gas; and
a second tuning gas flow controller for supplying a supplementary etching gas.

8. The system of claim 7, wherein the supplementary gas supplier connects to the outlet ducts of the mass flow control unit through a sixth supply duct, and the first tuning gas flow controller and second tuning gas flow controller connect to the gas distribution duct through a seventh supply duct.

9. The system of claim 8, wherein the flow rate control unit comprises a flow rate controller and a gas distribution duct, and
wherein the gas distribution duct comprises:
a plurality of outlet ducts;
first and second supply ducts branched from the one-side outlet duct and connected to a center nozzle and a side nozzle of the upper gas injector, respectively; and
third and fourth supply ducts branched from the other-side outlet duct and connected to the side nozzle and the side gas injector, respectively,
wherein the second and third supply ducts are integrated into a fifth supply duct and connected to the side nozzle, and
wherein the seventh supply duct installs a branch point (D), and the branch point (D) installs branch ducts connected to the first, fourth, and fifth supply ducts, respectively.

10. The system of claim 9, wherein open/close valves are installed in outlet ducts provided in the first tuning gas flow controller and second tuning gas flow controller and the branch ducts, respectively.

11. The system of claim 8, wherein the sixth supply duct installs a branch point (C), and has a connection duct connecting the branch point (C) with the seventh supply duct.

12. The system of claim 11, wherein open/close valves are installed in the sixth supply duct branched from the branch point (C) and the connection duct, respectively.

13. The system of claim 7, wherein the active gas is an oxygen (O₂) or nitrogen (N₂) gas.
